(19) United States
(12) Patent Application Publication
(10) Pub. No.: US 2003/0196116 A1
(43) Pub. Date: Oct. 16, 2003

(54) Electronic mail blocking system

(76) Inventor: Todd Troutman, Atmore, AL (US)

Correspondence Address: Michael S. Neustel, Suite No. 4, 2534 South University Drive, Fargo, ND, 58103, US

(21) Appl. No.: 10/124,070

(22) Filed: Apr. 15, 2002

(51) Int. Cl. H04L 9/00

(52) U.S. Cl. 713/201

(57) ABSTRACT

An electronic mail blocking system for reducing undesirable electronic mail that a recipient receives. The electronic mail blocking system filters one or more electronic messages transmitted by a sender having a sender identity to a mail server addressed to a receiver. The electronic mail blocking system comprises comparing the sender identity to an authorized sender list and transmitting the electronic message if the sender identity matches a record within the authorized sender list. The mail server automatically transmits an authentication request containing a question to the sender when the sender identity does not match a record within the authorized sender list. A response containing an answer from the sender in response to the authentication request is compared to a correct answer. If the answer is a correct response to the question, the mail server transmits the electronic message to the recipient and automatically adds the sender to the authorized sender list.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to electronic mail filters and more specifically it relates to an electronic mail blocking system for reducing undesirable electronic mail that a recipient receives.

With the proliferation of connections to the Internet by a rapidly growing number of individuals, the viability of the Internet as a widely accepted medium of communication and business activity has increased correspondingly. The Internet is comprised of a global computer network allowing various types of data to be transmitted including but not limited to video, audio and graphical images. The type of connection the individual has to the Internet determines the overall quality and speed of their Internet experience. With increasing bandwidth and decreasing prices of Internet connections available to consumers such as DSL, ISDN, T1, T3 and cable modems, increased usage and quality of Internet related activities will inevitably occur.

Electronic mail (e-mail) communications are an increasingly popular means of communicating between individuals. The e-mail may be composed and transmitted via the Internet utilizing conventional e-mail software programs such as MICROSOFT OUTLOOK. The e-mail may be comprised of a textual, rich text or HTML (hyper text markup language) format.

Unfortunately, there has been an increased usage of unsolicited commercial bulk e-mail and other types of junk e-mail often times referred to as “spam.” The number of unsolicited commercial electronic messages received by the average American in 2001 was 571, according to JUPITER MEDIA METRIX. In addition to wasting people's time with unwanted e-mail, spam also consumes a significant amount of network bandwidth. Consequently, there are many organizations, as well as individuals, who have taken it upon themselves to fight spam with a variety of techniques. But because the Internet is public, there is really little that can be done to prevent spam in a broad based manner. However, some private online services, such AMERICA ONLINE, have instituted policies to prevent spammers from spamming their subscribers which have been somewhat effective in reducing the amount of spam. Hence, there is a need for a system that effectively blocks unsolicited commercial e-mail and other undesirable e-mail.

2. Description of the Related Art

Electronic mail filtering programs have been in use for years. Conventional electronic mail filtering systems are typically dependent upon a specified criteria such as expressions contained within the e-mail. For example, many e-mail filters search for expressions that are commonly utilized within undesirable e-mails.

One of the main problems with e-mail filters is that they are often times surpassed by clever spammers. In addition, e-mail filters tend to block some desirable e-mail along with the undesirable e-mail, an uncomfortable compromise for anyone who relies on e-mail for personal or business reasons. Another problem with e-mail filters is that they must be constantly monitored and updated by the user to ensure up-to-date filtering of e-mail messages.

Examples of patented devices which are related to the present invention include U.S. Pat. No. 6,249,805 to Fleming, III; U.S. Pat. No. 6,266,692 to Greenstein; U.S. Pat. No. 6,195,698 to Lillibridge et al.; U.S. Pat. No. 6,167,434 to Pang; U.S. Pat. No. 6,249,807 to Shaw et al.; U.S. Pat. No. 6,167,435 to Druckenmiller et al.; U.S. Pat. No. 6,161,130 to Horvitz et al.; U.S. Pat. No. 6,092,101 to Birrell et al.; U.S. Pat. No. 6,023,723 to McCormick et al.; and U.S. Pat. No. 5,999,932 to Paul.

While these Internet based systems may be suitable for the particular purpose to which they address, they are not as suitable for reducing undesirable electronic mail that a recipient receives. Conventional e-mail filters do not effectively reduce unsolicited commercial e-mail messages.

In these respects, the electronic mail blocking system according to the present invention substantially departs from the conventional concepts and designs of the prior art, and in so doing provides a system primarily developed for the purpose of reducing undesirable electronic mail that a recipient receives.

### BRIEF SUMMARY OF THE INVENTION

In view of the foregoing disadvantages inherent in the known types of electronic mail filters now present in the prior art, the present invention provides a new electronic mail blocking system wherein the same can be utilized for reducing undesirable electronic mail that a recipient receives.

The general purpose of the present invention, which will be described subsequently in greater detail, is to provide a new electronic mail blocking system that has many of the advantages of the electronic mail filters mentioned heretofore and many novel features that result in a new electronic mail blocking system which is not anticipated, rendered obvious, suggested, or even implied by any of the prior art electronic mail filters, either alone or in any combination thereof.

The electronic mail blocking system filters one or more electronic messages transmitted by a sender having a sender identity to a mail server addressed to a receiver. The electronic mail blocking system comprises comparing the sender identity to an authorized sender list and transmitting the electronic message if the sender identity matches a record within the authorized sender list. The mail server automatically transmits an authentication request containing a question to the sender when the sender identity does not match a record within the authorized sender list. A response containing an answer from the sender in response to the authentication request is compared to a correct answer. If the answer is a correct response to the question, the mail server transmits the electronic message to the recipient and automatically adds the sender to the authorized sender list.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an electronic mail blocking system that will overcome the shortcomings of the prior art systems.

A second object is to provide an electronic mail blocking system for reducing undesirable electronic mail that a recipient receives.

Another object is to provide an electronic mail blocking system that reduces unsolicited electronic messages.

An additional object is to provide an electronic mail blocking system that decreases the amount of time an individual spends viewing undesirable e-mail messages.

A further object is to provide an electronic mail blocking system that reduces the amount of data transmitted to an e-mail recipient.

Another object is to provide an electronic mail blocking system that does not utilize expression blocking.

A further object is to provide an electronic mail blocking system that may be utilized within as an extension of a recipient mail server or as a third-party electronic mail blocking service.

Another object is to provide an electronic mail blocking system that automatically creates an authorized sender list.

A further object is to provide an electronic mail blocking system that may be utilized in conjunction with various message communication tools such as but not limited to computers, cell phones, pagers, personal digital assistants (PDAs) and text messaging devices.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an exemplary computer system.

FIG. 2 is a block diagram illustrating the communications between a sender and a recipient.

FIG. 3 is a flowchart illustrating the present invention.

FIG. 4 illustrates an example of a sample e-mail page including a sender authentication request utilizing a question format.

FIG. 5 illustrates an example of a sample e-mail page including a sender authentication request utilizing a yes/no format.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

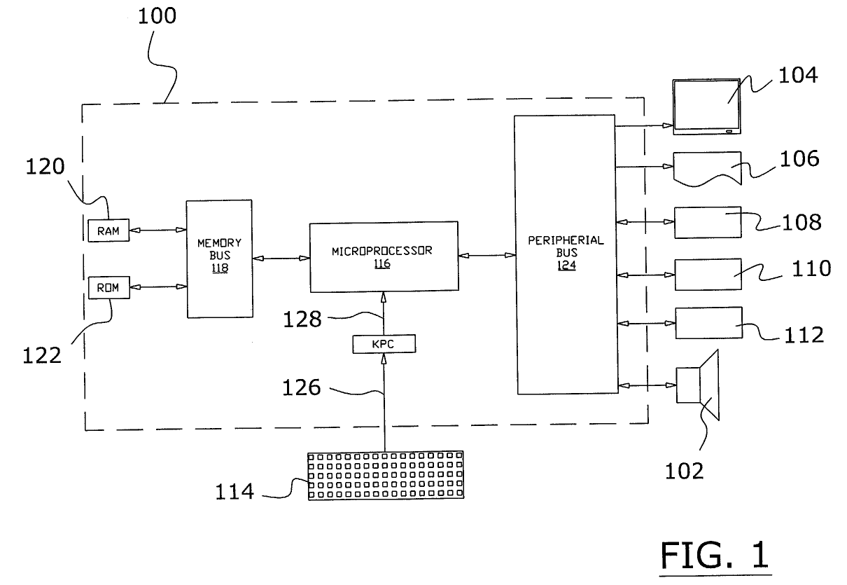

FIG. 1 is a block diagram of an exemplary computer system 100 for practicing the various aspects of the present invention. The computer system 100 includes a display screen (or monitor) 104, a printer 106, a floppy disk drive 108, a hard disk drive 110, a network interface 112, and a keyboard 114. Computer system 100 includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 120. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

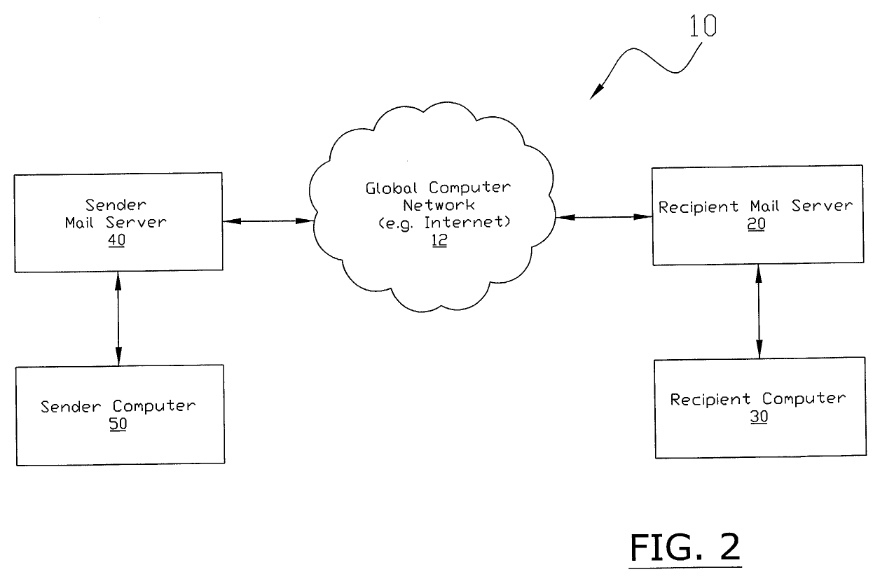

As shown in FIG. 2, the Internet 12 is comprised of a “global computer network”. A plurality of computer systems 100 around the world are in communication with one another via this global computer network. The present invention may be implemented upon the Internet 12 or wireless communication systems, however it can be appreciated that as future technologies are created that various aspects of the invention may be practiced with these improved technologies.

FIG. 2 further illustrates the usage of a sender computer 50 in communication with a sender mail server 40 connected to the Internet 12. The sender computer 50 generates an electronic message (e-mail) that is sent to the sender mail server 40 which transmits the e-mail to a recipient mail server 20 via the Internet or other communication medium.

The recipient mail server 20 is programmed to send only messages from “authorized senders” as contained upon an Authorized Senders List (ASL). The ASL is preferably empty as the initial default setting thereby not allowing any e-mails addressed to the recipient to be sent to the recipient computer 30. However, the recipient may input authorized senders directly into the ASL at anytime. In addition, the recipient may also remove any authorized senders from the ASL at anytime.

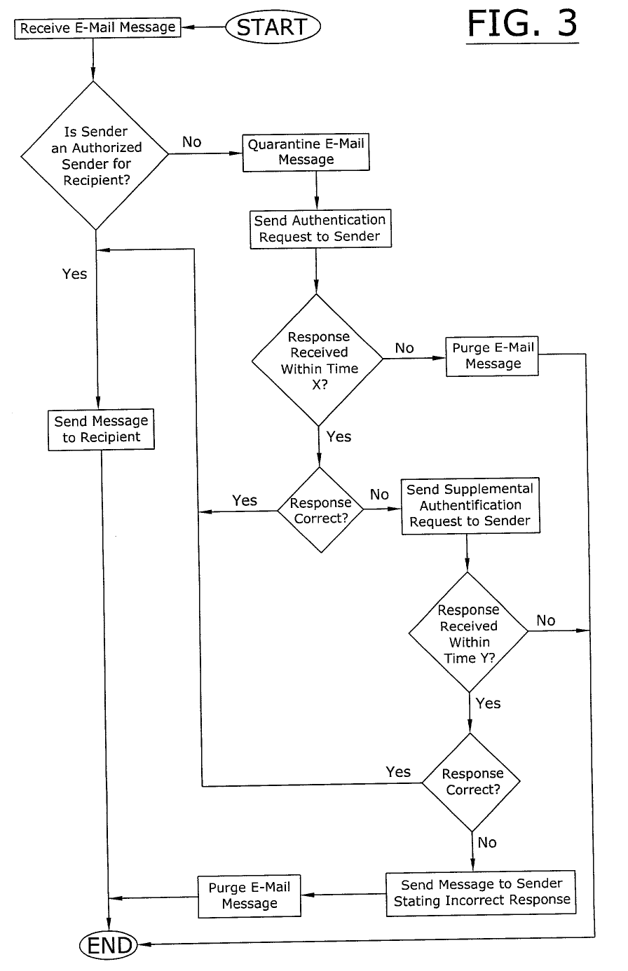

FIG. 3 illustrates the operation and functionality of the present invention. The first step within the invention is the receipt of an e-mail message from a sender addressed to the recipient by the recipient mail server 20. The recipient mail server 20 compares the listing of authorized senders upon the ASL with the identity of the sender within the e-mail message. The identity of the sender may be comprised of the sender's reply e-mail address, the name of the sender or other identifying data. If the identity of the sender is contained within the ASL, then the message is allowed to be sent to the recipient computer 30 from the recipient mail server 20 as shown in FIG. 3.

However, if the identity of the sender of the e-mail message is not contained within the ASL, the recipient mail server 20 retains the e-mail message within a “quarantine” until the sender's identity can be authenticated as shown in FIG. 3 of the drawings. The recipient mail server then automatically sends an “authentication request” message to the sender requesting a proper and desirable response as illustrated in FIGS. 3 through 5 of the drawings.

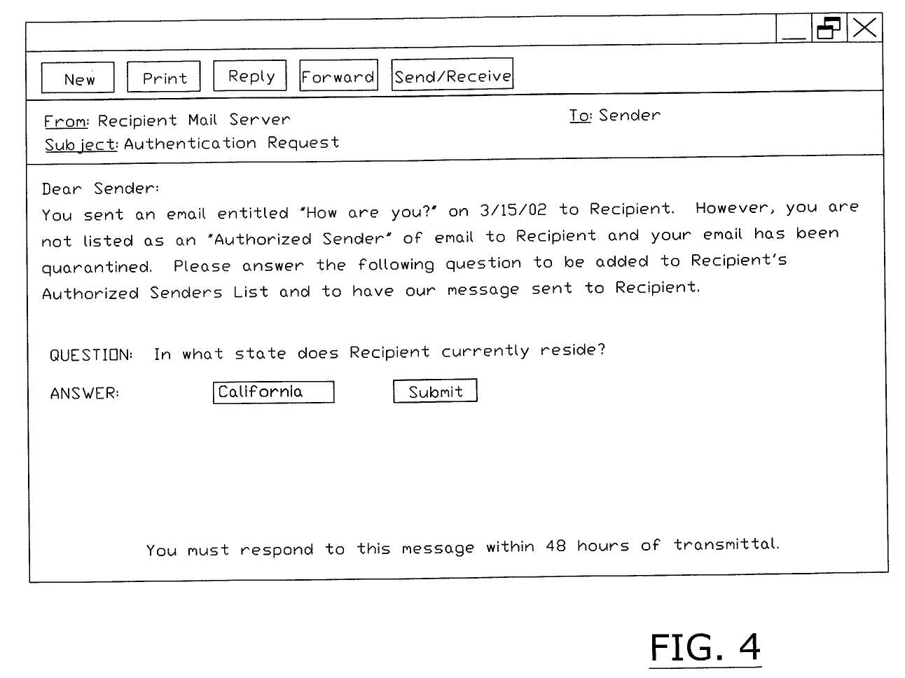

FIG. 4 illustrates an example of an authentication request providing a question and requesting a correct answer to the question from a Question-Answer Database (QAD). The answer is preferably input utilizing an data input box as shown in FIG. 4, however, drop-down menus, radio buttons and selection buttons may be utilized for the sender to input the answer. Various other formats may be utilized to submit the answer to the question from the QAD.

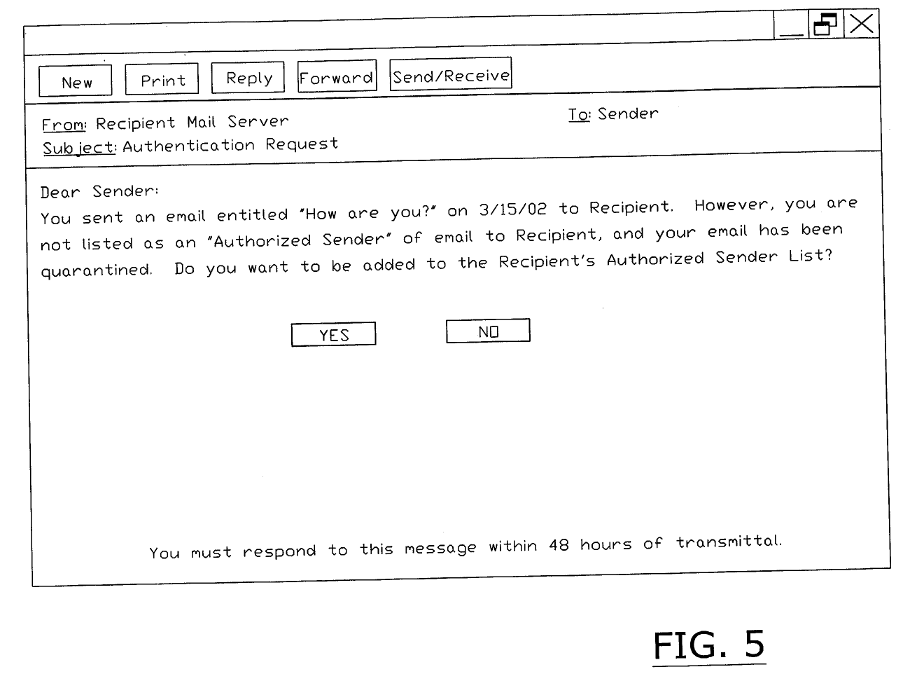

The question within the authentication request preferably is comprised of topic related to the recipient, however various other topics may be utilized to confirm the legitimacy of the sender. The recipient may change the question and the desired answer at anytime within the QAD and may have more than one question/answer within which may be randomly selected. In addition, the question and answer may be comprised of a list of standard questions/answers contained upon the recipient mail server 20 such as “What is the country to the north of the United States?”. The authentication request may also be comprised of a format simply requiring the selection of a button (yes or no) as shown in FIG. 5 of the drawings.

The authentication request may utilize an applet, web application or other application technology. The authentication request may be contained within the message or as an attachment thereto. An applet is a program written in the JAVA programming language that can be included in an HTML page, much in the same way an image is included. When an individual uses a JAVA technology-enabled browser to view a page that contains an applet, the applet's code is transferred to the individual's computer system and executed by the browser's JAVA Virtual Machine (JVM). Here is an example of a simple applet tag: <applet code=“MyApplet.class” width=100 height=140></applet>. A “standalone JAVA application” may also be utilized which is a JAVA program that is run by invoking the java interpreter. Here is an example of a standalone JAVA application: java authenticationApplication. It can be appreciated that the authentication request may include a hyperlink to a web page that includes the authentication request form.

If the reply e-mail address of the sender is invalid and the authentication request is returned to the recipient mail server 20, the recipient mail server 20 preferably will delete the corresponding e-mail message. In addition, if the sender does not submit a correct response to the authentication request within time X, the recipient mail server 20 preferably will delete the corresponding e-mail message. The recipient preferably sets the time X to a time period the recipient feels is sufficient for desirable senders to respond thereto. The recipient typically will increase time X during the initial period of usage of the present invention to ensure desirable senders are provided adequate time to provide a response and then reduce time X after a significant portion of desirable senders have been added to the ASL. For example, the recipient may set time X to two days during the first month of using the present invention and then to one day thereafter.

If the sender submits a response to the authentication request, the recipient mail server then compares the sender's answer to the correct answer within the QAD. If the sender's answer is correct, the e-mail message from the sender is then transmitted from the recipient mail server 20 to the recipient computer 30 along with preferably automatically adding the sender's identity to the ASL. However, the recipient may adjust the settings of the recipient mail server 20 such that further authorization from the recipient is required before adding a sender to the ASL or for automatically sending further instructions to the sender on how to become an authorized sender.

If the sender submits a response that is incorrect, this indicates that there is an increased probability that the sender is providing a potentially desirable e-mail. Hence, supplemental procedures may be utilized to further screen the sender even though an incorrect answer is provided by the sender. For example, a “supplemental authentication request” may be sent to the sender by the recipient mail server 20 which contains a second question in a format similar to the original question as shown in FIGS. 3 through 5 of the drawings.

The supplemental authentication request preferably also includes a statement indicating that the first submitted response by the sender was incorrect. The sender is then provided an opportunity to respond to the supplemental authentication request within time Y. Since the likelihood that the sender is a legitimate sender based upon the attempted response to the first question by the sender, the recipient typically will set time Y to a period longer than time X to ensure that the sender has adequate time to respond. However, time Y may be comprised of a period shorter than time X. If the sender submits a response to the supplemental authentication request within time X, the recipient mail server then compares the sender's answer to the correct answer within the QAD. If the sender's answer is correct, the e-mail message from the sender is then transmitted from the recipient mail server 20 to the recipient computer 30 along with automatically adding the sender's identity to the ASL. The recipient may adjust the settings of the recipient mail server 20 such that further authorization from the recipient is required before adding the sender to the ASL even though a correct answer was provided by the sender. If the answer to the supplemental authentication request is incorrect, the e-mail message is preferably purged though it can be appreciated that additional supplemental authentication requests may be sent to the sender by the recipient mail server 20 as set by the recipient.

The present invention is preferably implemented at the recipient mail server 20. However, the present invention may be implemented as a third-party e-mail screening service that intercepts e-mail messages prior to submission to the recipient mail server 20. The present invention may also be implemented upon the recipient computer 30 as a separate application or as an add-in for an existing electronic mail application. The recipient may adjust the settings of the present invention utilizing a web interface or a client side application.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Electronic Mail Blocking System

□
□
□
□
□
□
□
□
□
□
□ 10. Electronic Mail Blocking System
□ 11.
□ 12. Internet
□ 13.
□ 14.
□ 15.
□ 16.
□ 17
□ 18
□ 19.
□ 20. Recipient Mail Server
□ 21.
□ 22.
□ 23.
□ 24.
□ 25.
□ 26.
□ 27.
□ 28.
□ 29.
□ 30. Recipient Computer
□ 31.
□ 32.
□ 33.
□ 34.
□ 35.
□ 36.
□ 37.
□ 38.
□ 39.
□ 40. Sender Mail Server
□ 41.
□ 42.
□ 43.
□ 44.
□ 45.
□ 46.
□ 47.
□ 48.
□ 49.
□ 50. Sender Computer
□ 51.
□ 52.
□ 53.
□ 54.
□ 55.
□ 56.
□ 57.
□ 58.
□ 59.
□ 60.
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.
□ 100. Computer System
□ 101.
□ 102. Speaker
□ 103.
□ 104. Display Screen
□ 105.
□ 106. Printer
□ 107.
□ 108. Floppy Disk Drive
□ 109.
□ 110. HardDiskDrive
□ 111.
□ 112. Network Interface
□ 113.
□ 114. Keyboard
□ 115.
□ 116. Microprocessor
□ 117.
□ 118. Memory Bus
□ 119.
□ 120. RAM
□ 121.
□ 122. ROM
□ 123.
□ 124. Peripheral Bus
□ 125.
□ 126. Keyboard Controller
□ 127.
□ 128. Bus
□ 129.
□ 130.
□ 131.
□ 132.
□ 133.
□ 134.
□ 135.
□ 136.
□ 137.
□ 138.
□ 139.
□
□
□
□
□
□
□
□
□
□
□
□
□
□
□
□
□
□
□
□
□
□
□
□
□
□
□
□
□
□
□
□
□
□
□
□
□
□
□
□
□

I claim:

1. An electronic mail blocking system, comprising:
a question-answer database containing at least one question and at least one corresponding answer;
an authorized sender list containing identities of authorized senders; and
a recipient mail server for receiving an electronic message from a sender addressed to a recipient, wherein said recipient mail server compares an alleged identity from said sender with said authorized sender list to determine whether to transmit said electronic message to said recipient, wherein said recipient mail server sends an authentication request containing a question from said question-answer database to said sender if said sender is not contained within said authorized sender list, and wherein said recipient mail server compares a response from said sender to said authentication request to a corresponding answer within said question-answer database wherein if said response is correct then said electronic message is transmitted to said recipient and said sender is automatically added to said authorized sender list.

2. The electronic mail blocking system of claim 1, wherein said question-answer database is comprised of data input by said recipient.

3. The electronic mail blocking system of claim 1, wherein said question-answer database is comprised of standard questions with corresponding standard answers.

4. The electronic mail blocking system of claim 1, wherein said authentication request includes an applet.

5. The electronic mail blocking system of claim 4, wherein said applet requests an answer utilizing a text input box.

6. The electronic mail blocking system of claim 4, wherein said applet requests an answer utilizing a drop-down menu.

7. The electronic mail blocking system of claim 4, wherein said applet requests an answer utilizing a plurality of radio buttons.

8. The electronic mail blocking system of claim 4, wherein said applet requests an answer utilizing at least one selection button.

9. The electronic mail blocking system of claim 1, wherein said recipient may adjust said authorized sender list.

10. The electronic mail blocking system of claim 1, wherein said recipient mail server deletes said electronic message after time X if no response is received from said sender to said authentication request.

11. The electronic mail blocking system of claim 1, wherein if said response is incorrect then said recipient mail server sends a supplemental authentication request to said sender.

12. An article of manufacture comprising a computer usable medium having computer readable program code embodied therein for blocking electronic message, said computer readable program code in the article of manufacture comprising:
computer readable program code for causing a computer to scan an electronic message from a sender for a sender address;
computer readable program code for causing a computer to determine whether said sender address matches an address within an authorized sender list;
computer readable program code for causing a computer to quarantine said electronic message when said sender address does not match with an address within said authorized sender list and to automatically transmit an authentication request containing an authentication question to said sender address;
computer readable program code for causing a computer to read a response from said sender containing an authentication answer in response to said authentication question; and
computer readable program code for causing a computer to transmit said electronic message to an intended receiver and add said sender address to said authorized sender list upon determining that said authentication answer is correct.

13. A method of filtering an electronic message transmitted by a sender having a sender identity to a recipient mail server addressed to a receiver, said method comprising the steps of:
(a) comparing said sender identity to an authorized sender list and transmitting said electronic message if said sender identity matches a record within said authorized sender list;
(b) automatically transmitting an authentication request containing a question to said sender when said sender identity does not match a record within said authorized sender list;
(c) comparing a response containing an answer from said sender in response to said authentication request; and p1 (d) determining if said answer is a correct response to said question, transmitting said electronic message to said recipient if said answer is a correct response and automatically adding said sender to said authorized sender list.

14. The method of filtering an electronic message of claim 13, further comprising the following step:
(e) automatically transmitting a supplemental authentication request containing a supplemental question to said sender when said answer is incorrect;
(f) comparing a supplemental response containing a supplemental answer from said sender in response to said supplemental authentication request; and
(g) determining if said supplemental answer is a correct response to said supplemental question, transmitting said electronic message to said recipient if said supplemental answer is a correct response and automatically adding said sender to said authorized sender list.

15. The method of filtering an electronic message of claim 14, including the following step:
(h) deleting said electronic message if a response is not received within time Y.

16. The method of filtering an electronic message of claim 13, including the following step:
(e) deleting said electronic message if a response is not received within time X.

17. The electronic mail blocking system of claim 13, wherein said authentication request includes an applet.

18. The electronic mail blocking system of claim 17, wherein said applet requests an answer utilizing a text input box.

19. The electronic mail blocking system of claim 17, wherein said applet requests an answer utilizing a drop-down menu.

20. The electronic mail blocking system of claim 13, wherein said authentication request includes an application for providing said answer to said question.
